(19) United States
(12) Patent Application Publication
(10) Pub. No.: US 2007/0212152 A1
(43) Pub. Date: Sep. 13, 2007

(54) Keyboard configuration

(76) Inventor: Chien-Tsung Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/370,930

(22) Filed: Mar. 9, 2006

(51) Int. Cl. B41J 5/00

(52) U.S. Cl. 400/489

(57) ABSTRACT

The present invention is a keyboard configuration comprising a plurality of key matrixes and a plurality of sets of keys. A first set of keys disposed in the key matrix has a ↑-character key, a ↓-character key, a ←-character key and a →-character key. A second set of keys disposed in the key matrix has a W-character key, an A-character key, an S-character key and a D-character key. A third set of keys disposed in the key matrix has an I-character key, a J-character key, a K-character key and an L-character key. A fourth set of keys disposed in the key matrix has a 4-character key, a 5-character key, a 6-character key and an 8-character key. A fifth set of keys disposed in the key matrix has a 2-character key, the 4-character key, the 6-character key and the 8-character key. Both each scan line and each return line could be any character key in any set of keys are different from the other scan lines and return lines are the other relative characters in a same set.

### FIELD OF THE INVENTION

The present invention relates to a keyboard configuration and particularly a keyboard configuration applied in playing games, could prevent ghost keys condition happened.

### BACKGROUND OF THE INVENTION

The U.S. Pat. No. 4,888,600, titled “KEYBOARD ARRANGEMENT WITH GHOST KEY CONDITION DETECTION” disclosed ghost key condition detection and the circuit thereof, to solve the problem of ghost keys on a keyboard. However, adding a detecting circuit will raise the manufacturing cost.

The prior keyboard configuration for IBM PC or compatible computer is used to control direction while playing games, and due to that the prior keyboard configuration has only one set of keys such as ↑-key, ↓-key, ←-key, →-key, etc. for controlling direction and detecting ghost keys. Other sets of controlling directions such as W-key, A-key, S-key, D-key, etc. may not prevent the ghost keys conditions happened. Hence this is inconvenient for PC game players.

In order to overcome the disadvantage of the prior art, the inventor of the present invention provides a keyboard configuration and method thereof for multiple sets of direction-control keys and preventing the occurrence of ghost keys, which most overcomes the disadvantage of the prior art.

### SUMMARY OF THE INVENTION

The primary object of the present invention is to provide a keyboard configuration, where the multiple sets of keys are controlling directions while PC game players entering any set of keys or other keys simultaneously prevent s ghost keys from happening.

To approach the above object, the present invention provides a keyboard configuration which comprises: a plurality of key matrixes and a plurality of sets of keys; a first set of keys disposed in the key matrix having a ↑-character key, a ↓-character key, a ←-character key and a →-character key; a second set of keys disposed in the key matrix having a W-character key, an A-character key, an S-character key and a D-character key; a third set of keys disposed in the key matrix having an I-character key, a J-character key, a K-character key and an L-character key; a fourth set of keys disposed in the key matrix having a 4-character key, a 5-character key, a 6-character key and an 8-character key; and a fifth set of keys disposed in the key matrix having a 2-character key, the 4-character key, the 6-character key and the 8-character key; wherein each scan line and each return line that belong to any character key in any set of keys are different from the other scan lines and return lines that belong to the other relative characters in a same set.

### BRIEF DESCRIPTION OF THE DRAWINGS

These objects and other objects and advantages of the present invention will become more apparent upon reading of the following detailed description and the accompanying drawings in which:

FIG. 1 is a schematic view showing a circuit structure of a keyboard of the present invention;

FIG. 2 and FIG. 3 are schematic view showing another circuit structure of the keyboard of the present invention;

FIG. 4 is an arrangement showing a plurality of characters of a first embodiment of the keyboard of the present invention; and

FIG. 5 is an arrangement showing a plurality of characters of a second embodiment of the keyboard of the present invention.

### DETAILED DESCRIPTION OF THE INVENTION

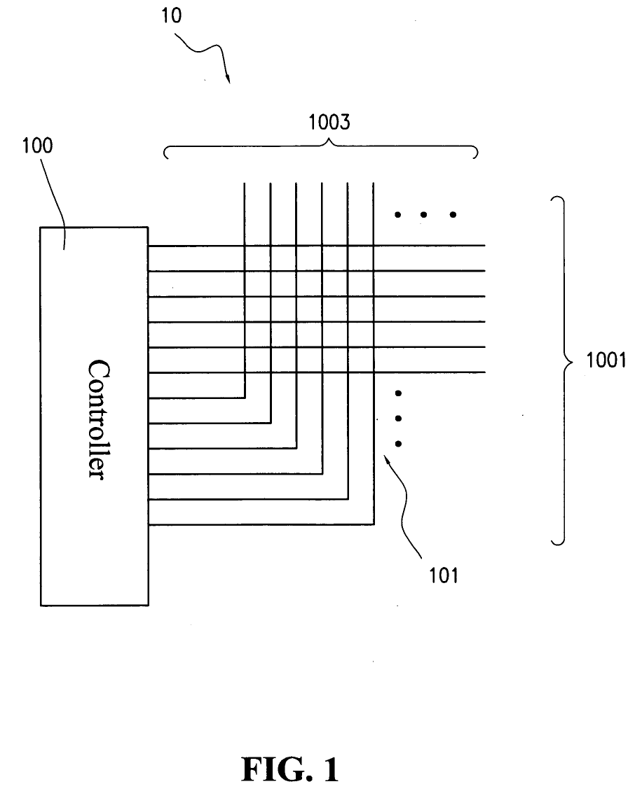

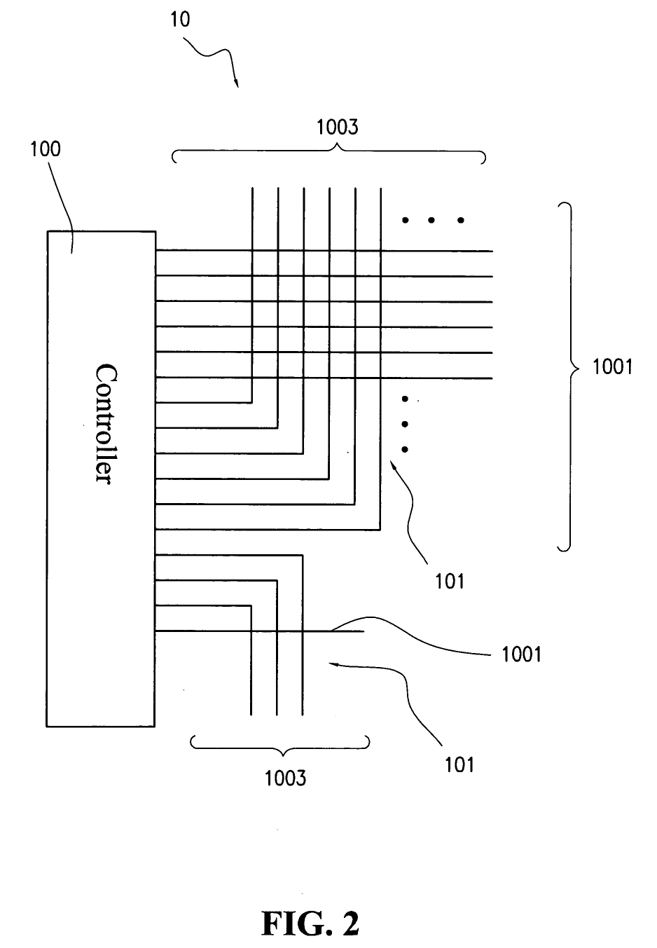

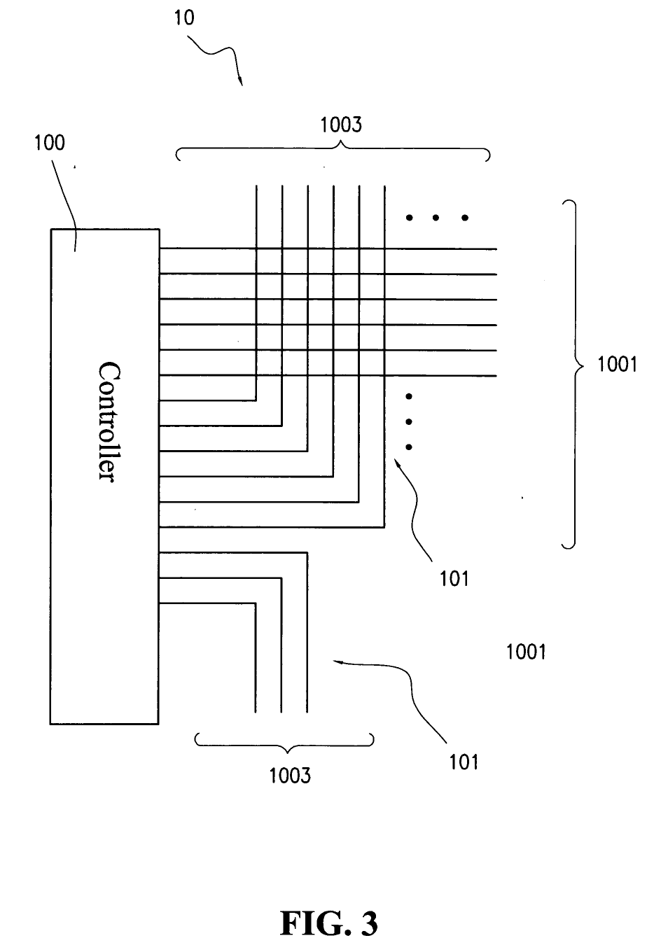

Please refer to FIG. 1, which is a schematic view showing a circuit structure of a keyboard of the present invention. As shown in FIG. 1, the keyboard 10 uses an I/O port of a controller 100 as scan lines 1001 and return lines 1003. The scan lines 1001 and the return lines 1003 construct a key matrix 101. The keyboard 10 discloses that a plurality of characters from the first set of keys to the fifth set of keys is arranged to the key matrix 101 to prevent ghost keys. According to a real occurring amount of a total key number for the keyboard 10, the amount of the arranged key matrix 101 can be at least one, and each key matrix 101 is independent. Please refer to FIG. 2 and FIG. 3, which are schematic view showing another circuit structure of the keyboard of the present invention. The keyboard 10 can be utilized to an IBM PC or a compatible computer, such as an 83-key keyboard, a 101-key keyboard, a 104-key keyboard or others.

The aforesaid first set of keys to fifth set of keys are defined as: a first set of keys having a ↑-character key, a ↓-character key, a ←-character key and a →-character key; a second set of keys having a W-character key, an A-character key, an S-character key and a D-character key; a third set of keys having an I-character key, a J-character key, a K-character key and an L-character key; a fourth set of keys having a 4-character key, a 5-character key, a 6-character key and an 8-character key; and a fifth set of keys having a 2-character key, the 4-character key, the 6-character key and the 8-character key. Wherein the 4-character key, the 6-character key and the 8-character key are simultaneously defined in both the fourth set of keys and the fifth set of keys, and the 2-character key and the 5-character key are jointly disposed a numeral area of the keyboard 10.

Generally the characters belonged to the first set of keys to the fifth set of keys are utilized to control directions for many kinds of game software. In a set of keys, more than one key may be activated while playing a game; further, if more keys are pressed down, then most of the traditional keyboards may have ghost keys condition occurred. On the other hand, to operate any set of the first set of keys to the fifth set of keys of the keyboard 10 will prevent such condition happened.

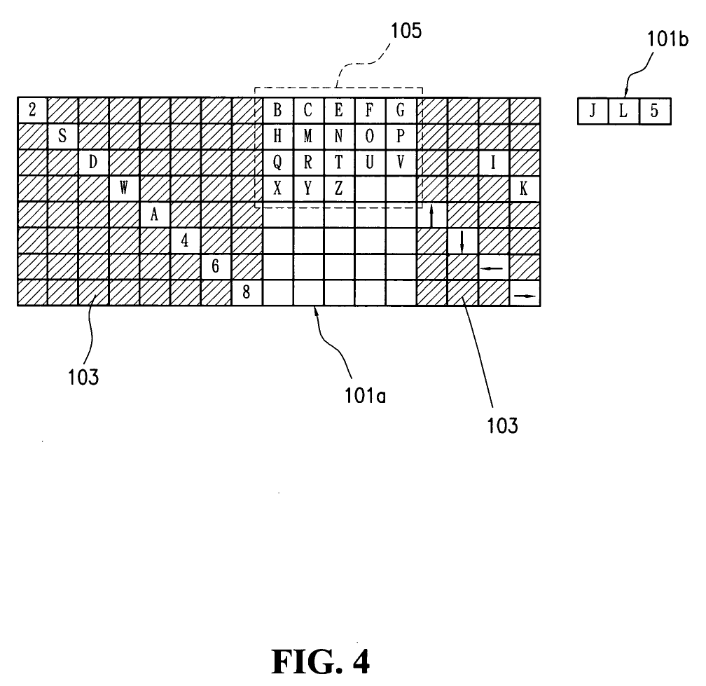

The following discloses a first preferred embodiment of the keyboard 10 of the present invention according to FIG. 2 or FIG. 3. Please refer to FIG. 4, which is an arrangement showing a plurality of characters of a first embodiment of the keyboard of the present invention. The keyboard 10 includes a key matrix 101a, a key matrix 101b and the first set of keys to the fifth set of keys. The key matrix 101a is composed of 8 scan lines and 17 return lines; the key matrix 101b is composed of 1 scan line and 3 return lines. The key matrix 101a is independent to the key matrix 101b. The key matrix 101a has the first set of keys, the second set of keys, the fifth set of keys, the I-character key and the K-character key of the third set of keys, the 4-character key, and the 6-character key and the 8-character key of the fourth set of keys. The key matrix 101b has the J-character key and the L-character key of the third set of keys and the 5-character key of the fourth set of keys. Please note that: the plurality of scan lines and the plurality of return lines belonged to any character key of the plurality sets of keys of the key matrix 101a are different than the other scan lines and return lines belonged to the other relative characters in a same set. For example, the scan lines and the return lines belonged to the ↑-character key are different than the scan lines and the return lines belonged to other three characters as the ↓-character key, the ←-character key and the →-character key in the first set of keys.

In addition, in the key matrix 101a, all of the scan lines and the return lines of the characters intersect another key matrix, which is defined as a key intersecting matrix 103, please refer to the oblique lines of FIG. 4. In the keyboard 10, there is not any key within the key intersecting matrix 103. Other keys 105 are arranged in the area without the key intersecting matrix 103. Therefore, in case of even only one key 105 being activated while any set of keys of the first set to the fifth set are operated, the present invention is able to prevent the condition of ghost keys.

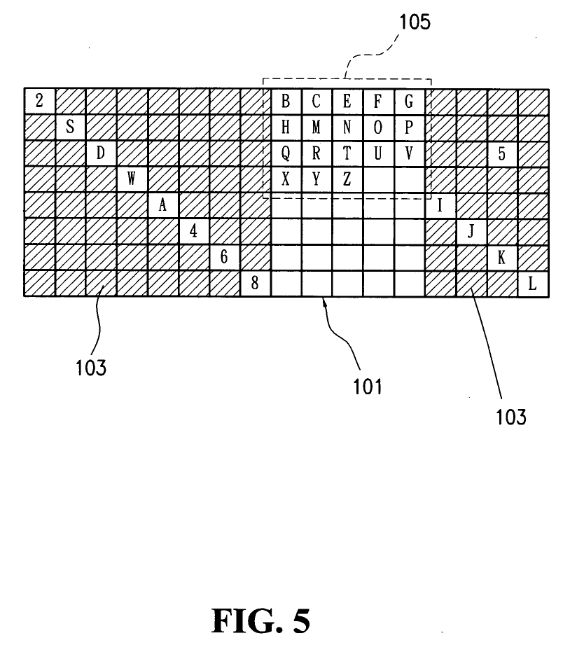

The following discloses a second preferred embodiment of the keyboard 10 of the present invention according to FIG. 1. Please refer to FIG. 5, which is an arrangement showing a plurality of characters of a second embodiment of the keyboard of the present invention. The keyboard 10 of the second preferred embodiment may decrease the total amount of keys by way of the consideration of unnecessary keys. Thus all of the keys of the keyboard 10 may be disposed in the single key matrix 101. The key matrix 101 in FIG. 5 is composed of 8 scan lines and 17 return lines. There are the second set of keys, the third set of keys, the fourth set of keys and the fifth set of keys in the key matrix 101. The plurality of scan lines and the plurality of return lines belonged to any character key of the plurality sets of keys of the key matrix 101 are different than the other scan lines and return lines belonged to the other relative characters in the same set. For example, the plurality of the scan lines and the plurality of the return lines belonged to the W-character key of the second set of keys are different than the scan lines and the return lines belonged to the other three characters, the A-character key, the S-character key and the D-character key, in the second set of keys.

Other keys 105 in FIG. 5 are arranged in the area without the key intersecting matrix 103. Please refer to the key intersecting matrix 103 of the oblique lines in FIG. 5. Therefore, even if only the key 105 being activated while any set of keys of the first set to the fifth set are operated, the present invention is able to prevent the condition of ghost keys.

Because the probability of the ↑-character key and the ↓-character key of the first set of keys being activated simultaneously is very low, the ↑-character key and the ↓-character key jointly utilize the same scan lines and return lines. Logically, the opportunity of the ←-character key and the →-character key of the first set of keys being activated simultaneously is very low, the ←-character key and the →-character key jointly utilize the same scan lines and return lines.

The keyboard configuration of the present invention provides multiple sets of keys for controlling directions for computer games, such as the characters are the first set of keys to the fifth set of keys. Further, a plurality of keys are activated simultaneously when operating the characters of any set of keys and other keys for playing games, the keyboard configuration is capable of keeping away from the situation of ghost keys.

Various embodiments and changes may be made thereunto without departing from the broad spirit and scope of the invention. The above-described embodiment is intended to illustrate the present invention, not to limit the scope of the present invention.

The scope of the present invention is shown by the attached claims rather than the embodiment. Various modifications made within the meaning of an equivalent of the claims of the invention and within the claims are to be regarded to be in the scope of the present invention.

What is claimed is:

1. A keyboard configuration comprising:
a key matrix having M scan line and N return line, wherein M is greater than zero and N is greater than zero;
a first set of keys disposed in the key matrix having a ↑-character key, a ↓-character key, a ←-character key and a →-character key;
a second set of keys disposed in the key matrix having a W-character key, an A-character key, an S-character key and a D-character key;
a third set of keys disposed in the key matrix having an I-character key, a J-character key, a K-character key and a L-character key;
a fourth set of keys disposed in the key matrix having a 4-character key, a 5-character key, a 6-character key and an 8-character key; and
a fifth set of keys disposed in the key matrix having a 2-character key, the 4-character key, the 6-character key and the 8-character key; wherein scan line and return line respectively different from any other character key in the same set.

2. The keyboard configuration of claim 1, wherein the keyboard configuration further comprises a key-intersecting matrix composed of all scan lines and return lines of the plurality of characters, the key-intersecting matrix does not have any other key.

3. The keyboard configuration of claim 1, wherein both each scan line and return line belonged to any character key in the five sets of keys are different than the other scan lines and return lines belonged to the other relative characters in a same set.

4. A keyboard configuration comprising:
a first key matrix having M scan lines and N return lines , wherein M is greater than zero and N is greater than zero;
a second key matrix being independent to the first matrix;
a first set of keys having a ↑-character key, a ↓-character key, a ←-character key and a →-character key;
a second set of keys having a W-character key, an A-character key, an S-character key and a D-character key;
a third set of keys having an I-character key, a J-character key, a K-character key and a L-character key;
a fourth set of keys having a 4-character key, a 5-character key, a 6-character key and an 8-character key; and
a fifth set of keys having a 2-character key, the 4-character key, the 6-character key and the 8-character key; wherein at least two sets of keys of the five sets of keys are disposed in the first key matrix, both each scan line and each return line belonged to any character key of any set of keys in the two sets of keys are different than the other scan lines and return lines belonged to the other relative characters in a same set; and all of the characters of other three sets of keys are disposed in the first key matrix and the second key matrix separately.

5. The keyboard configuration of claim 4, wherein the keyboard configuration further comprises a key-intersecting matrix composed of all scan lines and return lines of the plurality of characters of the first key matrix, the key-intersecting matrix does not have any other key.

6. The keyboard configuration of claim 4, wherein both each scan line and return line belonged to any character key in the two sets of keys are different than the other scan lines and return lines belonged to the other relative characters in a same set.

7. The keyboard configuration of claim 4, wherein the second key matrix has I scan lines and J return lines, wherein I is greater than zero and J is greater than zero.

8. The keyboard configuration of claim 4, wherein the second key matrix has I scan lines and J return lines, wherein I is greater than zero and J is equal to zero.

9. The keyboard configuration of claim 4, wherein the second key matrix has I scan lines and J return lines, wherein I is equal to zero and J is greater than zero.

10. The keyboard configuration of claim 4, wherein the second key matrix has I scan lines and J return lines, wherein I is greater than zero and J is equal to one.

11. The keyboard configuration of claim 4, wherein the second key matrix has I scan lines and J return lines, wherein I is equal to one and J is greater than zero.

12. The keyboard configuration of claim 4, wherein the ↑-character key of the first set of keys is changeable for location thereof, and can jointly use a scan line or a return line with the ↓-character key.

13. The keyboard configuration of claim 4, wherein the ←-character key of the first set of keys is changeable for location thereof, and can jointly use a scan line or a return line with the →-character key.

14. A keyboard configuration comprising:
a first key matrix having M scan lines and N return lines;
at least one set of keys composed of four characters, and at least one of said sets of keys being disposed in the first key matrix; wherein both each scan line and each return line belonged to any character key in the set of keys are different than the other scan lines and return lines belonged to the other relative characters in a same set.

15. The keyboard configuration of claim 14, wherein the sets of keys are composed of following a first set of keys to a fifth set of keys:
a first set of keys having a ↑-character key, a ↓-character key, a ←-character key and a →-character key;
a second set of keys having a W-character key, an A-character key, an S-character key and a D-character key;
a third set of keys having an I-character key, a J-character key, a K-character key and a L-character key;
a fourth set of keys having a 4-character key, a 5-character key, a 6-character key and an 8-character key; and
a fifth set of keys having a 2-character key, the 4-character key, the 6-character key and the 8-character key.

16. The keyboard configuration of claim 14, wherein the keyboard configuration further comprises a key-intersecting matrix composed of all scan lines and return lines of the plurality of characters of the first key matrix, the key-intersecting matrix does not have any other key.

17. The keyboard configuration of claim 14, wherein M is greater than zero and N is greater than zero.

18. The keyboard configuration of claim 14, wherein M is greater than zero and N is equal to zero.

19. The keyboard configuration of claim 14, wherein M is equal to zero and N is greater than zero.

20. The keyboard configuration of claim 14, wherein M is greater than zero and N is equal to one.

21. The keyboard configuration of claim 14, wherein M is equal to one and N is greater than zero.

22. The keyboard configuration of claim 15, wherein the ↑-character key of the first set of keys is changeable for location thereof, and can jointly use a scan line or a return line with the ↓-character key.

23. The keyboard configuration of claim 15, wherein the ←-character key of the first set of keys is changeable for location thereof, and can jointly use a scan line or a return line with the →-character key.

24. The keyboard configuration of claim 14, wherein the keyboard configuration further comprises: a second key matrix, which is independent to the first key matrix, the sets of keys are disposed in the first key matrix and the second key matrix separately.
